(19) United States
(12) Patent Application Publication
(10) Pub. No.: US 2012/0215576 A1
(43) Pub. Date: Aug. 23, 2012

(54) ALLOCATING TASKS TO RESOURCES

(75) Inventors: David L. Jensen, Peekskill, NY (US); Yingdong Lu, Yorktown Heights, NY (US); Mark S. Squillante, Pound Ridge, NY (US)

(73) Assignee: INTERNATIONAL BUSINESS MACHINES CORPORATION, Armonk, NY (US)

(21) Appl. No.: 13/029,793

(22) Filed: Feb. 17, 2011

(51) Int. Cl. G06Q 10/00

(52) U.S. Cl. 705/7.13

(57) ABSTRACT

Tasks of varying sizes may be allocated to multiple knapsacks (resources) both with multiple dimensions (domain principles) of a given size according to one or more desired criteria. For instance, sales territory management involves determining the allocation of items (accounts) of varying sizes to multiple knapsacks (territories or sales representatives) both with multiple dimensions (business principles) of a given size according to one or more desired criteria.

### FIELD

The present application generally relates to computer systems, analytical methods and systems that solve resource allocation problems. The methodologies of the present disclosure may be used for allocating tasks to resources, for example, for allocating and managing territories of sales.

### BACKGROUND

Allocating different tasks to different resources is a complex problem, especially in the presence of changing factors such as conditions and constraints. For example, the management of sales territories has pervasive impact throughout a business entity and its organizations and is often looked as being a driver of financial success of a company. A step in such management involves identifying and comparing potential sales territories, and controlling the manner in which sales territories change over time based on business goals, constraints and conditions, and allocating the appropriate representatives to different territories. Thus far, however, there have been no formal methodologies to support or determine the best sales territory management according to any desired criteria.

### BRIEF SUMMARY

A method and system for allocating a set of tasks to resources may be provided. The method, in one aspect, may include determining a plurality of metrics values that quantify domain principles and applying a multiple, multidimensional stochastic knapsacks formulation using the plurality of metrics values, where a plurality of items representing a plurality of tasks respectfully are allocated to knapsacks representing resources and each item has an associated size that represents different characterizations of a task and a value that represents a quantifiable value for the task to be allocated to a resource.

A system for evaluating and determining a set of tasks to resources, in one aspect, may include a multiple, multidimensional stochastic knapsacks formulation, a module operable to determine a plurality of metrics values that quantify domain principles, and apply the multiple, multidimensional stochastic knapsacks formulation using the plurality of metrics values. A plurality of items representing a plurality of tasks respectfully are allocated to knapsacks representing resources and each item has an associated size that represents different characterizations of a task and a value that represents a quantifiable value for the task to be allocated to a territory.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 is a flow diagram illustrating a method for sales territory in one embodiment of the present disclosure.

FIG. 2 is a system diagram illustrating system components for sales territory management in one embodiment of the present disclosure.

### DETAILED DESCRIPTION

In one aspect, the present disclosure is directed to evaluating and determining a selected set of sales territories for a business entity, based on business objectives, constraints and conditions. A sales territory can include client accounts, product offerings, sales people, sales incentives, feedback loops, and others. In this disclosure, the use of the term “territory” is more general than common usage to integrate all aspects of a sales organization. Business objectives can include revenue, cost, profit, market share, geographical distance, and others. Business constraints can include market share, demand, market opportunities, supply, lead times, dynamic interactions among aspects of the sales territory, and others. Business conditions can include history, propensity to buy, market conditions, market potential, market opportunities, economic conditions, seasonal effects, adding/removing offerings, accounts, and/or sales force, and others.

Given market conditions and the current set of sales territories, the present disclosure in one aspect provides techniques to evaluate and determine a selected set of sales territories, what sequence of actions/policies/intermediate sales territories should be followed to move the business to a selected set of sales territories. Actions and policies can include how, where and/or when to apply changes in the time and space of a set of sales territories. Sales territory determination can include evaluating proposals for new accounts, offerings, and/or sales force within the context of an existing set of sales territories. Sales territory evaluation and determination can include changes in objectives, economic conditions, business policies, as well as changing management issues.

More generally, the present disclosure is directed to providing a highly scalable solution to handle very large problems. The present disclosure may apply generally to a wide range of resource allocation problems, not limited to sales territory optimization.

Specifically, the method and system of the present disclosure may be utilized to address the problem of allocating accounts to sales representatives according to established business principles and realistic opportunity estimates, where business principles represent metrics for quantifying the value of territory allocations. Examples of the metrics for quantifying the value of territory allocations may include territory similarity which measures deviation of revenue opportunity for a territory from any statistic of revenue (e.g., average revenue) for the territory, industry alignment which measures the number of industries covered by the territory, geographical alignment which is determined by distances among the client accounts allocated to the territory, delivery alignment which measures the number of delivery organizations required by the accounts allocated to the territory, and account limit which represents the number of client accounts allocated to the territory. In one aspect, one or more criteria for each business principle determine a score for territory allocations. Thresholds can be defined according to business conditions to partition the domain of scores to those that are perceived to have positive effects on the business goal and those to have negative effects. The system and method of the present disclosure may determine the sales territories and allocations to maximize the number of positive scores and minimize the number of negative scores, while maximizing the business principle values.

This determination involves the solution of a large scale non-linear mixed integer program. An efficient solution needs to be provided to support an interactive real-time computer program tool implementation. The present disclosure to address this problem observes that each business principle to be optimized is a guiding principle, as opposed to an absolute principle. In one embodiment, a characteristic of a desired optimal solution, from a problem-specific (business) perspective, provides roughly equal territory allocations along each business principle dimension. In another embodiment, the allocations along each business principle dimension can be specialized for each of the sales representatives to which the allocations are made, and in particular, can be of arbitrary size.

In either case, suppose the size of the territory allocation along each business principle dimension is known. The system and method of the present disclosure in one embodiment may reduce the problem to that of allocating items (accounts) of varying sizes to multiple knapsacks (territories or sales representatives) both with multiple dimensions (business principles) of a given size. Since some business principle dimensions involve uncertainty and/or include variability and/or volatility, the present disclosure considers the underlying mathematical multiple multidimensional stochastic knapsacks problem. This by itself may not be helpful as stochastic knapsack problems are just as difficult to solve as non-linear mixed integer programs. The present disclosure in one embodiment develops general solutions for the multiple, multidimensional stochastic knapsacks problem based on a probabilistic analysis, including the use of martingales, stopping times and other probabilistic structures for the stochastic processes underlying the knapsacks problem.

The present disclosure thus considers a more general class of stochastic knapsack problems than has been previously considered. Each of the items available for allocation and each of the knapsacks into which the items can be placed include multiple dimensions, where the size of an item for each dimension is drawn from a general probability distribution and the size of each dimension is fixed for every knapsack. The item size becomes known only after an attempt has been made to allocate the item into one of the knapsacks. A value is associated with each item which is realized upon successfully allocating the item into one of the knapsacks without capacity overflow. The value of the knapsack is a weight function of the values of all the items that have been allocated into the knapsack which is unique to the knapsack. The overall value of an allocation is a function of the values of all knapsacks under the allocation. The system and method of the present disclosure in one embodiment develops adaptive and non-adaptive classes of strategies for sequentially allocating a set of items among a collection of knapsacks with respect to maximizing the expected overall value of the allocation, and for establishing fundamental properties of these allocation strategies. In the problem of sales territory optimization respect, an item may represent a sales account, a knapsack may represent a sales territory or sales representative to which accounts are allocated. Item size may represent different characterizations of an account (e.g., revenue opportunity, industry, geographic location). A value associated with each item may represent the business value for an account to be allocated to a certain territory. A value of a knapsack may represent the business value pertaining to a specific territory. An overall value of an allocation may represent the overall business impact or output of a territory assignment.

The formulation in one embodiment of the present disclosure for the generalized stochastic knapsack problem is presented below. Consider the following stochastic knapsack problem that generalizes in several ways a standard stochastic variant of the classical knapsack problem. Let p≧1 denote the number of knapsacks, each of which has m≧1 dimensions with fixed size of every dimension. This problem can be scaled as needed in applications, so we can assume that the fixed size in each dimension is a constant (possibly different for each knapsack), which we shall further assume to be one in what follows solely for illustrative and expository purposes (without any such limitations on the present invention). Let n≧1 denote the number of items available for allocation into the multiple knapsacks, where the i th item has value vᵢ≧0 and size sᵢ=(sᵢ¹, . . . ,sᵢ^{m})≧0, i=1, . . . , n. The values vᵢ are assumed to be deterministic (though may be replaced by expected values under appropriate independence assumptions) and the sizes sᵢ^{j} are assumed to be independent random variables that follow general probability distributions F_{i-hu j}(·), i=1, . . . , n, j=1, . . . , m. Define I={1, . . . , n}, J={1, . . . , m} and K={1, . . . , p}. Then the problem of interest includes determining an allocation of the n items among the p knapsacks with the goal of maximizing the total value of the allocated items subject to the knapsack size constraints. More formally, our multiple multidimensional stochastic knapsacks problem is given by

$${max}_{{A}_{1} , … , {A}_{p}} {\sum }_{k = 1}^{p} {u}_{k} ( {\sum }_{i ∈ {A}_{k}}^{ } {v}_{i} ) , \\ s . t . {\sum }_{i ∈ {A}_{k}}^{ } {s}_{i}^{j} \leq 1 , \\ j ∈ J , k ∈ K , {A}_{k} ⋐ I , k ∈ K , {A}_{k} ⋂ {A}_{{k}^{′}} = 0 , k , {k}^{′} ∈ K , k \neq {k}^{′} , \qquad ( 1 )$$

where the decision variables Aₖ is the subset of items that are allocated to the k th knapsack and uₖ is a given weight for the k th knapsack, k ∈K. The probabilistic constraint,

$${\sum }_{i ∈ {A}_{k}}^{ } {s}_{i}^{j} \leq 1 , j ∈ J , k ∈ K ,$$

represents the limit for the characterizations related to the accounts, such as the total amount of revenue opportunity in a territory should not exceed a certain limit.

In one embodiment of the present disclosure, this multi-instance, multidimensional generalization of the stochastic knapsack problem is studied under a class of non-adaptive allocation strategies. We define a non-adaptive strategy to be a function π_{N}:I=I×J that maps a set of items I to a rank ordering of pairs of items in I and knapsacks in J. A non-adaptive strategy then includes allocating the items to the knapsacks following the rank order defined by π_{N}. Given any instance I of the problem, let T_{N}(I) denote the optimal expected value obtained by a non-adaptive strategy.

In another emodiment of the present disclosure, this multi-instance, multidimensional generalization of the stochastic knapsack problem is studied under a class of adaptive allocation strategies. We analogously define an adaptive strategy to be a function π_{A}:2^{A}×[0,1]^{|K|+J|}=A×J that maps a set A⊂I of remaining items and remaining available capacity c from among all p knapsacks to the pair of decision variables for the next knapsack allocation, namely the item and the knapsack to be allocated. An adaptive strategy would start with the initial set of items A=I and all p knapsacks empty, then apply π_{A} to allocate an item in A to one of the knapsacks while updating the set of remaining items A accordingly, and iteratively continuing in this manner to allocate the remaining items in A following π_{A} until either A becomes empty or all of the knapsacks overflow. Given any instance I of the problem, let T_{A}(I) denote the optimal expected value obtained by an adaptive strategy.

In yet another emodiment of the present disclosure, this multi-instance, multidimensional generalization of the stochastic knapsack problem is studied under a class of allocation strategies that combine both non-adaptive and adaptive schemes.

Now define μᵢ^{j}=E[sᵢ^{j} [symbol] 1] for all i ∈ I and j ∈ J , where [symbol] ( [symbol] ) denotes the min (max) operator, more specifically x [symbol] y=min(x, y) and x [symbol] y=max(x, y). For any set of items S [symbol] I and j ∈ J, define μ^{j}(S)=Σ_{i ∈S}μᵢ^{j}, χ^{j}(S)=Σ_{i ∈S}sᵢ^{j}, and χ(S)= [symbol] ⱼχ^{j}(S). An easy probabilistic inequality implies P[χ(S)<1]≦Πⱼ₌₁^{m}(1−μ^{j}(S)).

Example results are presented below. To elucidate the exposition, some of our results for the special case of p=1 and u₁=1 is presented initially, followed by a summary of the corresponding results for the general case.

Focusing initially on the one multidimensional stochastic knapsack, let us first consider the average performance of an adaptive strategy. To this end, we identify a martingale and a stopping time from the stochastic processes underlying the implementation of the adaptive strategy. We then apply the optimal stopping theorem to obtain an upper bound for the performance in the form of a polynomial function of μᵢ^{j}.

Fix an adaptive strategy π_{A} and let A be the set of items that has been successfully allocated into the multidimensional knapsack. Note that A is a random set. Then the next result provides a useful upper bound on the size of A. Specifically, optimal stopping can be applied to establish the fact that μⱼ(A)≦2− [symbol] ᵢμᵢ^{j}, for each j ∈ J.

This bound allows us to establish an upper bound on the performance of the adaptive strategy. In fact, for any instance of the multidimensional stochastic knapsack problem, the adaptive strategy can not produce a better performance than the linear relaxation of the knapsack problem with knapsack size, 2− [symbol] ᵢμᵢ^{j}. That is equivalent to T_{A}≦Φ( [symbol] ⱼ(2− [symbol] ᵢμᵢ^{j})), where the function Φ(t) is the value of the linear relaxation of the knapsack problem for knapsack with size t, which allows any item to be allocated fractionally into a knapsack.

Next we define the value density of each item i to be wᵢl( [symbol] ⱼμᵢ^{j}), where wᵢ=vᵢP[sᵢ^{j}≦1, ∀j∈J]. Without loss of generality, we can assume that the items are ranked in descending order of their value density, namely

w₁/ [symbol] ⱼμ₁^{j}≦w₂/ [symbol] ⱼμ₂^{j}≦ . . . ≦wₙ/ [symbol] ⱼμₙ^{j}.

### Define

$$r = min \{ q \text{:} {\sum }_{i = 1}^{q} {⋁}_{j} {μ}_{i}^{j} \geq 1 \} , \\ {p}^{′} = \frac{1 - {\sum }_{i = 1}^{r - 1} {⋁}_{j} {μ}_{i}^{j}}{{⋁}_{j} {μ}_{r}^{j}} , \\ {w}_{r}^{′} = {p}^{′} {w}_{r} , {w}_{j}^{′} = {w}_{j} , j = 1 , 2 , … , r - 1.$$

Then, in one embodiment, the methodology of the present disclosure may include the following non-adaptive randomized ranking strategy.

First, choose index l with probability w¹ₜ.
If l<r, allocate item l;
otherwise if l=r, allocate item r with probability p¹.

Finally, allocate items 1,2, . . . ,l−1, l−1, . . . , r in rank order.

Letting T_{R} denote the expected value of the allocation following this randomized ranking strategy, we can estimate the value of T_{R} though a detailed probabilistic analysis, and establish its lower bound as a polynomial of μᵢ^{j}.

The efficiency of the nonadaptive randomized ranking strategy is measured by the adaptivity gap, that is the ratio between T_{A} and T_{R}. The adaptivity gap can be obtained by optimizing the rational function T_{R}/T_{A} over a compact set.

The non-adaptive randomized ranking strategy achieves T_{R}≦(1/C₁)T_{A}, where C₁>1. The constant C₁ is independent of n and s, and only depends on m.

Focusing now on multiple multidimensional stochastic knapsacks, we turn to the original general multiple knapsack problem, and we assume without loss of generality that u₁≧u₂≧ . . . uₚ. It is clear that the multiple knapsack version of the above result continues to hold. To determine a non-adaptive randomized ranking strategy for multiple multidimensional stochastic knapsacks, we define

$${r}_{k} = min \{ q \text{:} {\sum }_{i = {r}_{k - 1} + 1}^{q} {⋁}_{j} {μ}_{i}^{j} \geq 1 \} , {r}_{1} = r , \\ {p}_{k}^{′} = \frac{1 - {\sum }_{i = {r}_{k - 1} + 1}^{{r}_{k} - 1} {⋁}_{j} {μ}_{i}^{j}}{{⋁}_{j} {μ}_{{r}_{k}}^{j}} , \\ {w}_{{r}_{k}}^{′} = {p}_{k}^{′} {w}_{{r}_{k}} , {w}_{j}^{′} = {w}_{j} , j = {r}_{k - 1} + 1 , {r}_{k - 1} + 2 , … , {r}_{k} - 1 ,$$

noting that the definition of r partitions I into p disjoint subsets {rₖ₋₁+1, rₖ₋₁+2, . . . , rₖ} with r₀=0.

The corresponding randomized ranking strategy proceeds as follows.

First, choose indices l₁, l₂, . . . lₚ with probability w¹ₜ_{₁},wⁱ^{t}_{₂}, . . . , w¹ₜ_{ₚ}.

Then randomly allocate item l_{q} to the qth knapsack, and allocate items r_{q-1}+1,r_{q-1}+2, . . . ,r_{q} into the qth knapsack in rank order.

Arguments similar to those in the one knapsack case can be applied to obtain the adaptivity gap for general multiple multidimensional stochastic knapsack problem.

Arguments similar to those in the one knapsack case can be applied to obtain the adaptivity gap for general multiple multidimensional stochastic knapsack problem. The randomized ranking strategy achieves expected value T_{R}≧(1/C₂)T_{A}, where C₂>1. The constant C₂ is independent of n and s, and only depends on m and p.

In one embodiment, a method is presented that combines a greedy search and a local search. The greedy search may be based on non-adaptive algorithm results of the present disclosure. The non-adaptive algorithm is C₁-optimal (its produces a performance whose value is within a C₁ multiple of the optimal value) with respect to an adaptive optimal algorithm which is a dynamic program. The local search is based on the adaptive algorithm results. The adaptive algorithm is C₂-optimal with respect to an off-line optimal algorithm. In one embodiment, the performance gap of the combined algorithm may be bounded as a combination of C₁ and C₂ in the worst case.

In one embodiment, the sales territory optimization methodology of the present disclosure may perform allocations over time dynamically with changing criteria, for example, changes in objective criteria, changes in economic conditions, changes in business policies, changes in sales opportunities, interactions among aspects of sales territories, changes in management rules or issues. For instance, based on such changes, sales territories may be allocated by incorporating the history of changes in various criteria, and dynamically adjusting the allocation according to the changes in those criteria. In one embodiment, dynamic allocation may be effected periodically, for instance, every quarter (¼ of a year) or every business cycle period, or other periods.

Yet in another embodiment, the sales territory management methodology of the present disclosure may perform allocations at different hierarchical levels. For instance, in an organization having hierarchically organized management, allocation of sales territories or accounts to lower level sales representatives may impact the aggregation of sales territories assigned to a manager of that sales representative. Thus, changes at a lower level may be hierarchically updated to a higher level. Similarly, allocation of sales territories and/or accounts at higher level among different organizations may impact the assignment of territories and account at lower level, since business objectives, constraints and conditions are different at different organizational levels. The sales territory management methodology may include iterative procedures for equilibriums to be reached so that the allocations between different organizational levels are consistent.

While the methodology of the present disclosure was described above with examples of allocating sales territory or accounts to sales representatives, the same methodology may be used for solving allocation problems generally, for example, allocating tasks or customers to resources. An example of a task may include a computational task for a computer system. An example of resources may be resources on a computer system such as central processing unit (CPU) capacity, memory and peripheries. Examples of assignment or allocation of tasks (or customers) to resources may include allocation of certain capacity of CPU, partition of memory and dedicated peripheries among multiple tasks. The size of resources may refer to the capacity of the resources, for example, sales territory size in the sales account to representative allocation example, capacity of a computer's CPU, memory and/or peripheries in computational task example. Examples of business principles may be generalized to domain principles or design principles or others, e.g., criterion for performance, service level guarantees (e.g., 90% of certain tasks need to be completed within 20 seconds). Thus, the present disclosure does not limit the application of the methodology disclosed herein to a sales territory allocation problem.

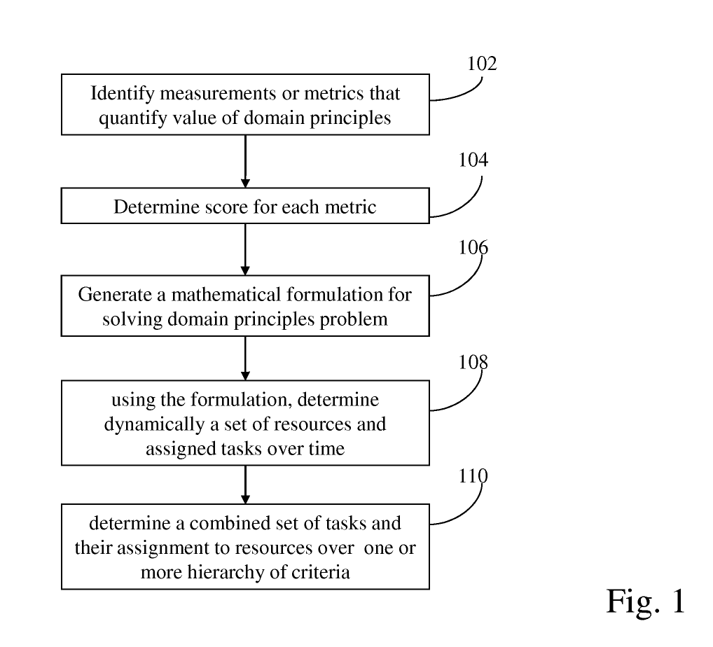

FIG. 1 illustrates a method of the present disclosure in one embodiment. At 102, a plurality of measurements or metrics that quantify value of domain principles are identified. At 104, score for each metric is determined. At 106, a mathematical formulation is generated for solving task to resource allocation problem, which maximizes number of positive scores and minimize the number of negative scores, and maximizes the metrics values. The formulation as described above may be a multiple, multidimensional stochastic knapsacks formulation. That is, the allocation problem may be mapped to a multiple, multidimensional stochastic knapsacks problem. A set of non-adaptive, adaptive, or both strategies may be used to solve the problem.

At 108, using the formulation, a set of resources and assigned tasks may be determined dynamically over time, for example, periodically. The dynamically determined resources and assigned tasks are based on changing criteria such as changes in objectives, economics, sales opportunities, and others. For example, a set of sales territories and assignments may be determined dynamically over time.

At 110, the method may also include determining a combined set of tasks and their assignment to resources over a hierarchy of criteria, including dynamic criteria such as changes in objectives, economics, sales opportunities, and others. For example, a combined set of sales territories and their assignments to sales representatives may be determined over a hierarchy of criteria.

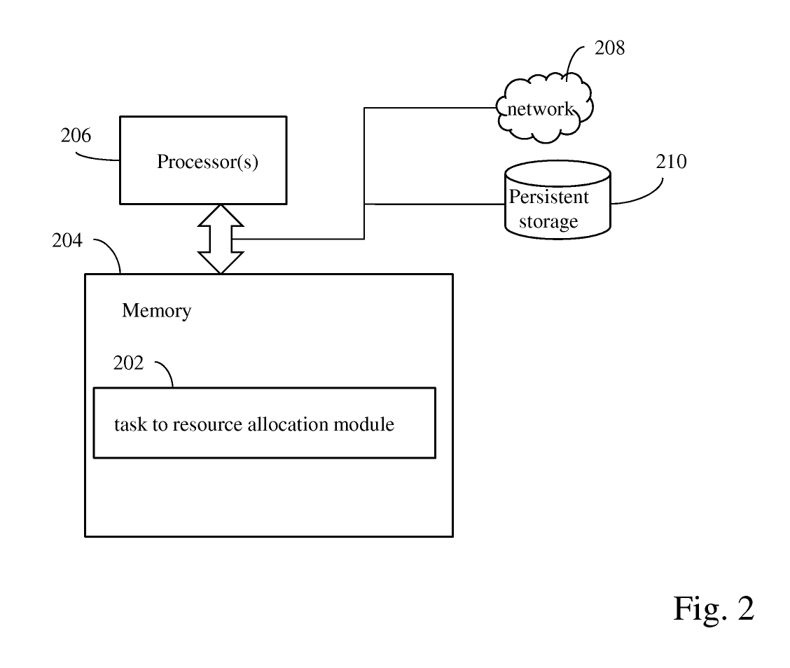

FIG. 2 illustrates a system of the present disclosure in one embodiment. A computer module 202 that includes computer instructions for performing task to resource (e.g., sales territory) allocation may be loaded into memory 204 and executed in one or more processors 206. A processor 206, for instance, may include hardware functional logic and registers for carrying out the instructions, for example, as one or more hardware threads. The system may also include network connections 208 and/or storage devices 210, for example, from and to which data may be communicated for performing the task to resource (e.g., sales territory) allocation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The systems and methodologies of the present disclosure may be carried out or executed in a computer system that includes a processing unit, which houses one or more processors and/or cores, memory and other systems components (not shown expressly in the drawing) that implement a computer processing system, or computer that may execute a computer program product. The computer program product may comprise media, for example a hard disk, a compact storage medium such as a compact disc, or other storage devices, which may be read by the processing unit by any techniques known or will be known to the skilled artisan for providing the computer program product to the processing system for execution.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer processing system that carries out the system and method of the present disclosure may also include a display device such as a monitor or display screen for presenting output displays and providing a display through which the user may input data and interact with the processing system, for instance, in cooperation with input devices such as the keyboard and mouse device or pointing device. The computer processing system may be also connected or coupled to one or more peripheral devices such as the printer, scanner, speaker, and any other devices, directly or via remote connections. The computer processing system may be connected or coupled to one or more other processing systems such as a server, other remote computer processing system, network storage devices, via any one or more of a local Ethernet, WAN connection, Internet, etc. or via any other networking methodologies that connect different computing systems and allow them to communicate with one another. The various functionalities and modules of the systems and methods of the present disclosure may be implemented or carried out distributedly on different processing systems or on any single platform, for instance, accessing data stored locally or distributedly on the network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A method of allocating a set of tasks to resources, comprising:
determining a plurality of metrics values that quantify domain principles; and
applying a multiple, multidimensional stochastic knapsacks formulation using the plurality of metrics values,
wherein a plurality of items representing a plurality of tasks respectfully are allocated to knapsacks representing resources and each item has an associated size that represents different characterizations of a task and a value that represents a quantifiable value for the task to be allocated to a resource.

2. The method of claim 1, wherein the formulation solves,
$${max}_{{A}_{1} , … , {A}_{p}} {\sum }_{k = 1}^{p} {u}_{k} ( {\sum }_{i ∈ {A}_{k}}^{ } {v}_{i} ) , \\ s . t . {\sum }_{i ∈ {A}_{k}}^{ } {s}_{i}^{j} \leq 1 , \\ j ∈ J , k ∈ K , {A}_{k} ⋐ I , k ∈ K , {A}_{k} ⋂ {A}_{{k}^{′}} = 0 , k , {k}^{′} ∈ K , k \neq {k}^{′} ,$$
wherein Aₖ is a subset of items that are allocated to k th knapsack and uₖ is a given weight for the k th knapsack, k ∈ K, and
$${\sum }_{i ∈ {A}_{k}}^{ } {s}_{i}^{j} \leq 1 , j ∈ J , k ∈ K ,$$
represents a constraint for characterizations related to the tasks.

3. The method of claim 1, wherein the formulation includes an adaptive algorithm, a non-adaptive algorithm, or combinations thereof.

4. The method of claim 1, wherein the plurality of items representing the plurality of tasks respectfully are allocated to knapsacks representing resources at different hierarchical levels.

5. The method of claim 1, further including:
repeating the step of applying using changing criteria, wherein the allocated tasks to resources are dynamically updated based on the changing criteria.

6. The method of claim 5, wherein the repeating is performed at every predetermined interval of time.

7. The method of claim 1, wherein the tasks include one or more of sales accounts, customers, or computer tasks.

8. The method of claim 1, wherein the resources include one or more of sales representatives, computer processor, computer memory, or computer peripheries.

9. A computer readable storage medium storing a program of instructions executable by a machine to perform a method of allocating a set of tasks to resources, comprising:
determining a plurality of metrics values that quantify domain principles; and
applying a multiple, multidimensional stochastic knapsacks formulation using the plurality of metrics values,
wherein a plurality of items representing a plurality of tasks respectfully are allocated to knapsacks representing resources and each item has an associated size that represents different characterizations of a task and a value that represents a quantifiable value for the task to be allocated to a resource.

10. The computer readable storage medium of claim 9, wherein the formulation solves,
$${max}_{{A}_{1} , … , {A}_{p}} {\sum }_{k = 1}^{p} {u}_{k} ( {\sum }_{i ∈ {A}_{k}}^{ } {v}_{i} ) , \\ s . t . {\sum }_{i ∈ {A}_{k}}^{ } {s}_{i}^{j} \leq 1 , \\ j ∈ J , k ∈ K , {A}_{k} ⋐ I , k ∈ K , {A}_{k} ⋂ {A}_{{k}^{′}} = 0 , k , {k}^{′} ∈ K , k \neq {k}^{′} ,$$
wherein Aₖ is a subset of items that are allocated to k th knapsack and uₖ is a given weight for the kth knapsack, k ∈ K , and
$${\sum }_{i ∈ {A}_{k}}^{ } {s}_{i}^{j} \leq 1 , j ∈ J , k ∈ K ,$$
represents a constraint for characterizations related to tasks.

11. The computer readable storage medium of claim 9, wherein the formulation includes an adaptive algorithm, a non-adaptive algorithm, or combinations thereof.

12. The computer readable storage medium of claim 9, wherein the plurality of items representing the plurality of tasks respectfully are allocated to knapsacks representing resources at different hierarchical levels.

13. The computer readable storage medium of claim 9, further including:
repeating the step of applying using changing criteria, wherein the allocated tasks to resources are dynamically updated based on the changing criteria.

14. The computer readable storage medium of claim 13, wherein the repeating is performed at every predetermined interval of time.

15. The computer readable storage medium of claim 9, wherein the tasks include one or more of sales accounts, customers, or computer tasks.

16. The computer readable storage medium of claim 9, wherein the resources include one or more of sales representatives, computer processor, computer memory, or computer peripheries.

17. A system for evaluating and determining a set of tasks to resources, comprising:
a processor;
a multiple, multidimensional stochastic knapsacks formulation;
a module operable to execute on the processor and determine a plurality of metrics values that quantify domain principles, and apply the multiple, multidimensional stochastic knapsacks formulation using the plurality of metrics values,
wherein a plurality of items representing a plurality of tasks respectfully are allocated to knapsacks representing resources and each item has an associated size that represents different characterizations of a task and a value that represents a quantifiable value for the task to be allocated to a territory.

18. The system of claim 17, wherein the formulation solves,
$${max}_{{A}_{1} , … , {A}_{p}} {\sum }_{k = 1}^{p} {u}_{k} ( {\sum }_{i ∈ {A}_{k}}^{ } {v}_{i} ) , \\ s . t . {\sum }_{i ∈ {A}_{k}}^{ } {s}_{i}^{j} \leq 1 , \\ j ∈ J , k ∈ K , {A}_{k} ⋐ I , k ∈ K , {A}_{k} ⋂ {A}_{{k}^{′}} = 0 , k , {k}^{′} ∈ K , k \neq {k}^{′} ,$$
wherein Aₖ is a subset of items that are allocated to k th knapsack and uₖ is a given weight for the k th knapsack, k ∈ K, and
$${\sum }_{i ∈ {A}_{k}}^{ } {s}_{i}^{j} \leq 1 , j ∈ J , k ∈ K ,$$
represents a constraint for characterizations related to tasks.

19. The system of claim 17, wherein the formulation includes an adaptive algorithm, or a non-adaptive algorithm, or combinations thereof.

20. The system of claim 17, wherein the plurality of items representing the plurality of tasks respectfully are allocated to knapsacks representing resources at different hierarchical levels.

21. The system of claim 17, further including:
repeating the step of applying using changing criteria, wherein the set of sales territories and associated assignments are dynamically updated based on the changing criteria.

22. The system of claim 21, wherein the repeating is performed at every predetermined interval of time.

23. The system of claim 17, wherein the tasks include one or more of sales accounts, customers, or computer tasks.

24. The system of claim 17, wherein the resources include one or more of sales representatives, computer processor, computer memory, or computer peripheries.
